(19) United States
(12) Patent Application Publication
(10) Pub. No.: US 2012/0150930 A1
(43) Pub. Date: Jun. 14, 2012

(54) CLOUD STORAGE AND METHOD FOR MANAGING THE SAME

(75) Inventors: Ki Sung JIN, Daejeon (KR); Hong Yeon Kim, Daejeon (KR); Young Kyun Kim, Daejeon (KR); Han Namgoong, Daejeon (KR)

(73) Assignee: Electronics and Telecommunications Research Institute, Daejeon (KR)

(21) Appl. No.: 13/289,276

(22) Filed: Nov. 4, 2011

(30) Foreign Application Priority Data
Dec. 10, 2010 (KR) 10-2010-0126397

(51) Int. Cl. G06F 17/30; G06F 15/16

(52) U.S. Cl. 707/827; 707/E17.01

(57) ABSTRACT

Disclosed is a cloud storage managing a plurality of files, including: a plurality of metadata servers managing a plurality of metadata associated with the plurality of files; a plurality of data servers managing the data of the plurality of files; and a cluster management server managing the plurality of metadata servers and the plurality of data servers.

### CROSS-REFERENCE TO RELATED APPLICATIONS

This application claims priority to and the benefit of Korean Patent Application No. 10-2010-0126397 filed in the Korean Intellectual Property Office on Dec. 10, 2010, the entire contents of which are incorporated herein by reference.

### TECHNICAL FIELD

The present invention relates to a cloud storage including a cluster management server, a plurality of metadata servers, a plurality of data servers, and at least one client and a method for managing the same.

### BACKGROUND

A cloud storage is a system that is configured to interconnect a plurality of data servers through a network.

A cloud storage is a system that is configured to interconnect a plurality of data servers through a network.

The above-mentioned network-based cloud storage can be easily expanded to several peta byte (PB) size by additionally mounting a data server when a service scale is increased, but restricts the number of maximally processable files because a single metadata server processes all the metadata and degrades the overall quality of service due to a performance bottleneck phenomenon of metadata of a file accessed by a user.

### SUMMARY

The present invention has been made in an effort to provide a method for managing a plurality of metadata servers for increasing expandability of metadata in a network connection type cloud storage and a system using the same.

Further, the present invention has been made in an effort to provide a cloud storage capable of distributing metadata of a user file in a plurality of metadata servers to distribute access load to the metadata and infinitely expanding the whole number of files processable by the cloud storage and a method for managing the same.

In addition, the present invention has been made in an effort to provide a method for constructing a cloud storage by using a plurality of metadata servers, a method for monitoring and managing resources of a metadata server and a data server, an operation method and a procedure of a cloud storage system configured of a plurality of metadata servers, a method for adding or removing a metadata server, and a method for rapidly migrating only metadata of a user file between metadata servers without migrating actual data.

An exemplary embodiment of the present invention provides a cloud storage managing a plurality of files, including: a plurality of metadata servers managing a plurality of metadata associated with the plurality of files; a plurality of data servers managing the data of the plurality of files; and a cluster management server managing the plurality of metadata servers and the plurality of data servers.

The cloud storage managing a plurality of files may further include at least one client performing an access to any files among the plurality of files.

The client may mount-connect with the cluster management server and then, perform the access to the plurality of metadata servers or the access to the plurality of data servers.

The metadata may include at least one of a file name, a file size, an owner, a file generation time, and positional information of a block in the data server.

The plurality of metadata servers may migrate a specific volume from the metadata server including the specific volume to other metadata servers included in the plurality of metadata servers when a ratio of a metadata storage space between the plurality of metadata servers is changed or user workload is concentrated on the specific volume.

The plurality of metadata servers may perform a predefined failure restoration process based on a file system restoration instruction transmitted from the cluster management server.

The plurality of metadata servers may perform an additional function of a new metadata serer or a removal function of the existing metadata server.

The cluster management server may include: a metadata server controller managing information on the plurality of metadata servers; a volume controller managing the plurality of volumes associated with the plurality of metadata servers; and a data server controller managing information on the plurality of data servers.

The metadata server controller may manage at least one state information of a host name, an IP, a CPU model name, CPU usage, a total memory size, memory usage, network usage, and disk usage of each metadata server of the plurality of metadata servers.

The volume controller may manage at least one state information of a volume name, a quarter allocated to the volume, volume usage, and workload information accessing the volume of each of the plurality of metadata servers.

The data server controller may manage at least one state information of a host name, an IP, a CPU model name, CPU usage, disk usage, and network usage of the data server of each of the plurality of data servers.

The cluster management server may inform the generated event contents through a predetermined e-mail or a short message service of a user when a predetermined event occurs.

The predetermined event may include at least one of an event indicating when the CPU usage of the data server is excessive, an event indicating when the network usage of the data server is excessive, an event indicating when the disk of the data server is full, an event indicating when the data server starts, an event indicating when the data server stops, an event indicating when the data server does not respond, an event indicating when the CPU usage of the metadata server is excessive, an event indicating when the network usage of the metadata server is excessive, an event indicating when the metadata server starts, an event indicating when the metadata server stops, an event indicating when the metadata server does not respond, and an event indicating when the volume storage space is full.

The cluster management server may include a remote procedure calling with any one of the plurality of metadata servers, the plurality of data servers, and the at least one client.

The remote procedure may include at least one of a network call instruction requesting the start of the metadata server, a network call instruction requesting the stop of the metadata server, a network call instruction requesting the addition of a new volume in the metadata server, a network call instruction requesting the removal of the existing volume in the metadata server, a network call instruction monitoring the metadata server information, a network call instruction requesting the start of the data server, a network call instruction requesting the stop of the data server, a network call instruction monitoring the data server information, a network call instruction mounting the file system, and a network call instruction releasing the file system.

Another exemplary embodiment of the present invention provides a method for managing a cloud storage including a plurality of metadata servers managing a plurality of metadata associated with the plurality of files, a plurality of data servers managing the data of the plurality of files, and a cluster management server managing the plurality of metadata servers and the plurality of data servers, the method including: transmitting a specific volume to any second metadata server included in the plurality of metadata servers by any first metadata server included in the plurality of metadata servers when a ratio of a metadata storage space between each of the plurality of metadata servers is changed or user workload is concentrated on the specific volume of the first metadata server; storing the received volume in a repository included in the second metadata server; transmitting information on the volume migration of the first metadata server and information on the volume generation of the second metadata server to the cluster management server; and updating the volume list included in the cluster management server based on the transmitted information on the volume migration of the first metadata server and the transmitted information on the volume generation of the second metadata server.

Yet another exemplary embodiment of the present invention provides a method for managing a cloud storage including a plurality of metadata servers managing a plurality of metadata associated with a plurality of files, a plurality of data servers managing the data of the plurality of files, and a cluster management server managing the plurality of metadata servers and the plurality of data servers, the method including: initializing a new metadata server to be newly added; driving a metadata server demon of the new metadata server and requesting the registration of the new metadata server to the cluster management server; and generating at least one volume storing the metadata from the new metadata server and requesting the registration of the at least one generated volume to the cluster management server.

Still another exemplary embodiment of the present invention provides a method for managing a cloud storage including a plurality of meta data servers managing a plurality of metadata, a plurality of data server managing the plurality of files, a cluster management server managing a plurality of metadata servers and the plurality of data servers, and at least one client, the method including: requesting a mount release of at least volume stored in the metadata server to be deleted among the plurality of metadata servers to the cluster management server by the client; releasing the mount of the at least one volume by the cluster management server in response to the at least one mount release request; removing the at least one volume managed by the metadata server to be deleted; requesting the deletion of information related to the metadata server to be deleted to the cluster management server; deleting the information related to the metadata server to be deleted from the metadata server list and the volume list by the cluster management server based on the deletion request of the information related to the metadata server to be deleted.

Still yet another exemplary embodiment of the present invention provides a method for managing a cloud storage including a plurality of meta data servers managing a plurality of metadata, a plurality of data server managing the plurality of files, a cluster management server managing a plurality of metadata servers and the plurality of data servers, and at least one client, the method including: requesting a mount of a specific volume to the cluster management server by the client; permitting the mount of the specific volume by the cluster management server in response to the mount request of the specific volume; requesting metadata information of any file to any metadata server including the specific volume among the plurality of metadata servers by the client; receiving the metadata information transmitted from any metadata server in response to the request; accessing any data server corresponding to the positional information of the file among the plurality of data servers based on the positional information of the file included in the received metadata information; requesting the mount release of the specific volume to the cluster management server by the client; and releasing the mount of the specific volume by the cluster management server in response to the mount release request of the specific volume.

Still yet another exemplary embodiment of the present invention provides a method for managing a cloud storage including a plurality of meta data servers managing a plurality of metadata, a plurality of data server managing the plurality of files, and a cluster management server a plurality of metadata servers and the plurality of data servers, the method including: transferring a file system restoration instruction to the plurality of metadata servers in the cluster management server when a failure occurs in any data server among the plurality of data servers; performing a predetermined failure restoration process based on the received file system restoration instruction by each of the plurality of metadata servers; and transmitting information on the failure restoration complete state to the cluster management server after the failure of each of the plurality of metadata servers is restored.

The exemplary embodiment of the present invention has the following effects.

First, the exemplary embodiment of the present distributes the metadata of the user file in the plurality of metadata servers in order to process the plurality of metadata of the user file, such that the plurality of metadata servers are used as the cloud storage platform in application environments such as the web portal storing and managing billions of files or more, the web mail, the VOD, or the storage lease service, etc., thereby making it possible to stably provide the data services.

Second, the exemplary embodiment of the present invention distributes the metadata of the user file in the plurality of metadata servers in order to process the plurality of metadata of the user file, thereby making it possible to increase the expandability of the metadata, distribute the access load to the metadata, and increase the management efficiency of the metadata of the user file and the data block (or data chunk).

### BRIEF DESCRIPTION OF THE DRAWINGS

FIG. 1 is a conceptual diagram of a cloud storage according to an exemplary embodiment of the present invention;

FIG. 2 is a diagram showing an example of managing resources of a cloud storage in a cluster management server according to an exemplary embodiment of the present invention;

FIG. 3 is a diagram showing an example of an event provided in the cluster management server according to an exemplary embodiment of the present invention;

FIG. 4 is a diagram showing an example of calling a remote procedure provided in the cluster management server according to an exemplary embodiment of the present invention;

FIG. 5 is a diagram showing a flow chart for explaining a method for migrating metadata between metadata servers according to an exemplary embodiment of the present invention;

FIG. 6 is a flow chart for explaining a method for adding new metadata servers according to an exemplary embodiment of the present invention;

FIG. 7 is a flow chart for explaining a method for removing the existing metadata servers according to an exemplary embodiment of the present invention;

FIG. 8 is a flow chart for explaining a method for allowing a client to mount a cloud storage according to an exemplary embodiment of the present invention; and

FIG. 9 is a flow chart for explaining a method for processing defects of data servers according to an exemplary embodiment of the present invention.

### DETAILED DESCRIPTION

Hereinafter, exemplary embodiments of the present invention will be described in detail with reference to the accompanying drawings. In this description, when any one element is connected to another element, the corresponding element may be connected directly to another element or with a third element interposed therebetween. First of all, it is to be noted that in giving reference numerals to elements of each drawing, like reference numerals refer to like elements even though like elements are shown in different drawings. The components and operations of the present invention illustrated in the drawings and described with reference to the drawings are described as at least one exemplary embodiment and the spirit and the core components and operation of the present invention are not limited thereto.

Exemplary embodiments of the present invention may be implemented through various units. For example, the exemplary embodiments of the present invention may be implemented by hardware, firmware, software, a combination thereof, or the like.

In case of the implementation by the hardware, a method according to the exemplary embodiments of the present invention may be implemented by one or more application specific integrated circuits (ASICs), digital signal processors (DPSs), digital signal processing devices (DSPDs), programmable logic devices (PLDs), field programmable gate arrays (FPGAs), processors, controllers, microcontrollers, microprocessors, or the like.

In case of the implementation by the firmware or the software, the method according to the exemplary embodiment of the present invention may be implemented by a type such as a module, a procedure, or a function, or the like, which performs the above-mentioned functions or operations. A software code may be stored in a memory unit and may be driven by a processor. The memory unit is disposed inside or outside the processor to transmit and receive data to and from the processor by various units that have been already known.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Further, a term, “module”, described in the specification implies a unit of processing at least one function or operation and can be implemented by hardware or software or a combination of hardware and software.

In the following description, specific terms are provided in order to assist the understanding of the present invention and the use of these specific terms may be changed in other types in the scope without departing from the technical idea of the present invention.

The present invention relates to a cloud storage including a cluster management server, a plurality of metadata servers, a plurality of data servers, and at least one client and a method for managing the same.

The exemplary embodiment of the present invention distributes a metadata of a file (or, user file) in the plurality of metadata servers by using the plurality of metadata servers to distribute the access load to the metadata, increase the expandability of the metadata, increase the management efficiency of the metadata and the data block (or the actual data of the file).

Hereinafter, exemplary embodiments of the present invention will be described in detail with reference to the accompanying drawings.

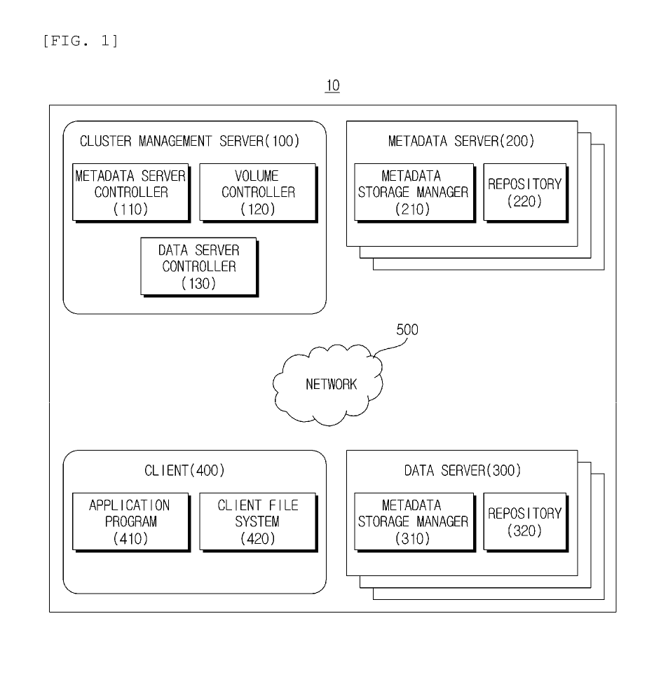

FIG. 1 is a conceptual diagram of a cloud storage 10 (cloud system or cloud storage system) according to an exemplary embodiment of the present invention.

The cloud storage 10 according to the exemplary embodiment of the present invention is configured to include a cluster management server 100, a plurality of metadata servers 200, a plurality of data servers 300, at least one client 400, and a network 500 interconnecting the components 100, 200, 300, and 400.

Each server 100, 200, and 300 included in the cloud storage 100 may be logically divided from each other and may be configured of a separate server or disposed in the same server.

The cluster management server 100 according to the exemplary embodiment of the present invention integrates and manages all the components included in the cloud storage 10 connected through the network 500. That is, the cluster management server 100 manages a registered metadata server list, a volume list managed in each metadata server 200, each data server list, attribute information of each component, or the like. The lists (including the metadata server list, the volume list, the data server list, or the like) are managed by using a hash table or a linked list (connection list: linked list).

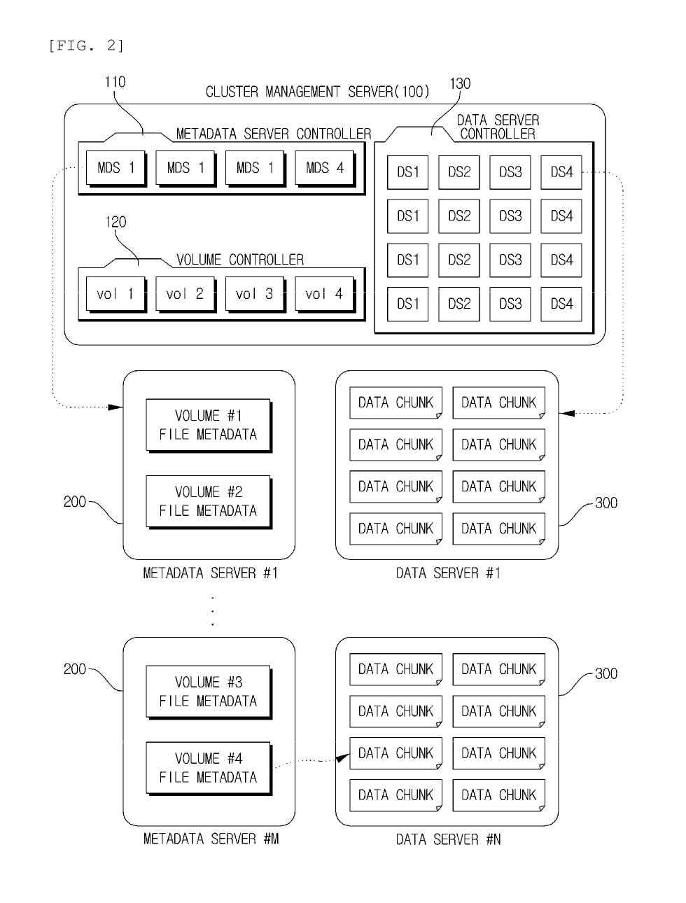

As shown in FIGS. 1 and 2, the cluster management server 100 is configured to include a metadata server controller 110, a volume controller 120, and a data server controller 130. In this configuration, FIG. 2 is a diagram showing an example of managing resources of the cloud storage 10 in the cluster management server 100.

The metadata server controller 110 according to the exemplary embodiment of the present invention manages the information on a plurality of metadata servers 200 (metadata servers #1 to #M shown in FIG. 2) connected to the cloud storage 10. That is, the metadata server controller 110 newly adds the information on the newly added metadata server to the metadata server list when the new metadata server is added to the cloud storage 10. In addition, when any metadata server included in the cloud storage 10 is removed, the metadata server controller 110 removes (or deletes) the information on the removed metadata server from the metadata server list. In this configuration, the metadata server list stores detailed state information of each metadata server. In addition, the state information includes at least one information of a host name, an IP, a CPU model name, CPU usage, a total memory size, memory usage, network usage, and disk usage of the metadata server. Further, the metadata server controller 110 periodically collects the state information from the plurality of metadata servers 200 and updates the metadata server list based on the collected state information.

The volume controller 120 according to the exemplary embodiment of the present invention manages the information related to all the volumes generated from the components included in the cloud storage 10. That is, the volume controller 120 adds the information on the newly generated volume to the volume list when the new volume is generated. In addition, the volume controller 120 deletes the information on the deleted volume from the volume list when any volume previously stored is deleted. In this configuration, the volume list stores the state information of each volume. In addition, the state information includes at least one information of volume name, quarter allocated to the volume, volume usage, workload information accessing the volume. The volume controller 120 periodically collects the state information of the volume from the plurality of metadata servers 200 and updates the volume list based on the collected volume state information.

The data server controller 130 according to the exemplary embodiment of the present invention manages the information on the plurality of data servers 300 (servers #1 to #N shown in FIG. 2) storing the actual data of the file. That is, when new data servers are added, the data server controller 130 newly adds the information on the newly added data servers to the data server list. In addition, when any data servers previously stored are deleted, the data server controller 130 deletes the information on the deleted data server from the data server list. In this configuration, the data server list stores the information on each data server. In addition, the state information includes at least one information of a host name, an IP, a CPU model name, CPU usage, disk capacity, disk usage, and network usage of the data server. In addition, the data server controller 130 periodically collects the state information from the plurality of data servers 300 and updates the data server list based on the collected state information.

Further, a user confirms each resource state information managed in the cluster management server 100 through a private utility for the user or when a predetermined event is generated, the cluster management server 100 informs the generated event using a predetermined e-mail or a short message service (SMS) of the user (or manager), such that rapid actions can be taken.

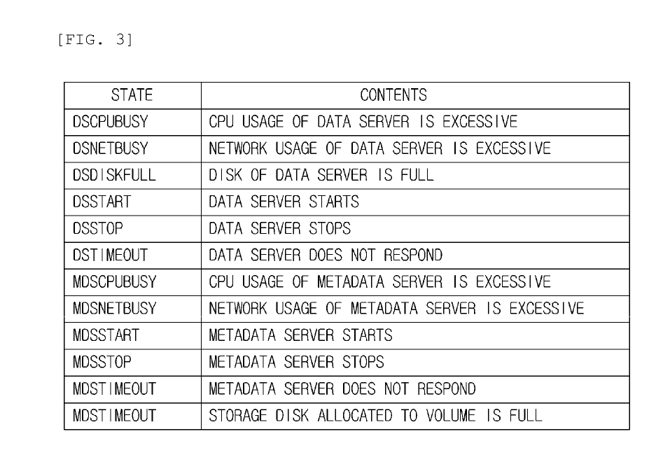

In this case, the predetermined event may be as shown in FIG. 3 and new events other than the events shown in FIG. 3 may be added or deleted by the user setting. In addition, the event name (or state name) described in the present invention may be variously changed by the user setting.

The “DSCPUBUSY” event according to the exemplary embodiment of the present invention occurs when the CPU usage of the data server 300 is excessive, which may occur when the I/O is concentrated on the data server 300. This problem may be solved by a method of additionally extending the data server 300 or a method of transferring some data to the data server 300 having a smaller load.

The “DSNETBUSY” event according to the exemplary embodiment of the present invention occurs when the network usage of the data server 300 is excessive, which may occur when the I/O is concentrated on the data server 300. This problem may be solved by a method of additionally extending the data server 300 or a method of transferring some data to the data server 300 having a smaller load, similar to the “DSCPUBUSY” event.

The “DSDISKFULL” event according to the exemplary embodiment of the present invention occurs in a case where the disk of the data server 300 is full, which may occur when the disk space mounted in the data server 300 is not sufficient. This problem may be solved by a method of additionally installing a disk when there is an empty disk bay in the data server 300 or a method of transferring some data to other data server 300 having an empty space.

The “DSSTART/DSSTOP” events according to the exemplary embodiment of the present invention occur when the data server 300 starts (or drives) or stops.

The “DSTIMEOUT” event according to the exemplary embodiment of the present invention occurs when the data server 300 does not respond, which may occur in the failure situations such as the power failure of the data server 300, the network fragmentation, or the like. This problem may be solved by performing the restoration procedure after sensing the situation.

The “MDSCPUBUSY” event according to the exemplary embodiment of the present invention occurs when the CPU usage of the metadata server 200 is excessive, which may occur when the metadata access request of the client 400 is concentrated on the metadata server 200. This problem may be solved by a method of transferring the volume registered in the metadata server 200 to the metadata server 200 having a smaller load.

The “MDSNETBUSY” event according to the exemplary embodiment of the present invention occurs when the network usage of the metadata server 200 is excessive, which may occur when the metadata access request of the client 400 is concentrated. This problem may be solved by a method of transferring the volume registered in the metadata server 200 to the metadata server 200 having a smaller load, similarly to the “MDSCPUBUSY” event.

The “MDSSTART/MDSSTOP” events according to the exemplary embodiment of the present invention occur when the metadata server 200 starts or stops.

The “MDSTIMEOUT” event according to the exemplary embodiment of the present invention occurs when the metadata server 200 does not respond, which may occur in the failure situations such as the power failure of the metadata server 200, the network fragmentation, or the like. This problem may be solved by performing the restoration procedure after sensing the situation.

The “VOLQUOTAFULL” event according to the exemplary embodiment of the present invention occurs when the volume storage space is full. This problem may be solved by increasing the quarter of the volume.

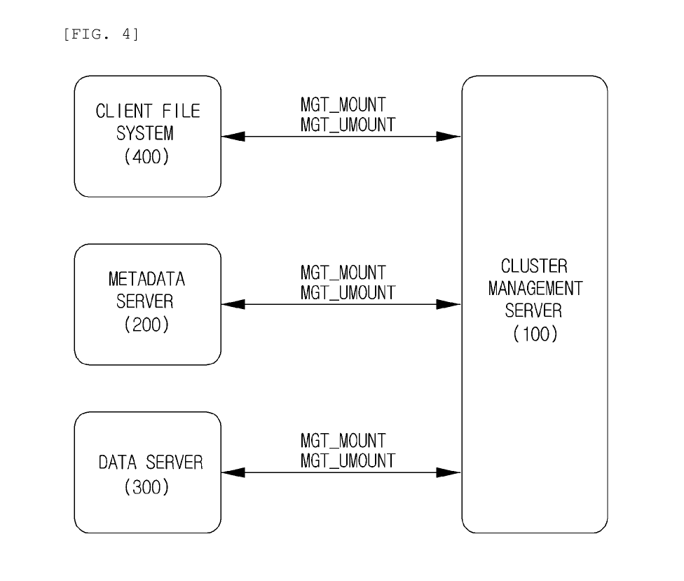

As shown in FIG. 4, the cluster management server 100 provides a previously established remote procedure to the plurality of metadata servers 200, the plurality of data servers 300, and at least one client 400, thereby transmitting and receiving instructions to and from the corresponding components through the remote procedure. In addition, the remote procedure name described in the present invention may be variously changed by the user setting

That is, as the remote procedure calling between the metadata server 200 and the cluster management server 100, there are a network call instruction MGT_MDSSTART requesting the start of the metadata server 200, a network call instruction MGT_MDSSTOP requesting the stop of the metadata server 200, a network call instruction MGT_ADDVOL requesting the addition of the new volume in the metadata server 200, a network call instruction MGT_RMVOL requesting the removal of the existing volume in the metadata server 200, a network call instruction MGT_MDSINFO monitoring the metadata server information (including the metadata server 200 and volume information), and the like.

As the remote procedure calling between the data server 300 and the cluster management server 100, there are a network call instruction MGT_DSSTART requesting the start of the data server 300, a network call instruction MGT_DSSTOP requesting the stop of the data server 300, a network call instruction MGT_DSINFO monitoring the data server information, and the like.

As the remote procedure calling between the client 400 and the cluster management server 100, there are a network call instruction MGT_MOUNT mounting a file system (or file system volume), a network call instruction MGT_UMOUNT releasing a file system, and the like.

Further, the cluster management server 100 performs the predetermined failure restoration procedure when the data server 300 does not respond due to various causes (for example, including power failure, network fragmentation, mainboard failure, kernel panic, or the like), thereby restoring the communication connection between the data server 300 and other components 100, 200, and 400 that are interconnected through the network 500.

The metadata server 200 according to the exemplary embodiment of the present invention is configured to include a metadata storage manager 210 and a repository 220.

Each metadata server 200 manages the metadata of the file and does not store the actual data of the file but stores the attribute information associated with the file. In this case, the attribute information of the file includes a file name, a file size, an owner, a file generating time, positional information of a block (or file) on the data server 300, and the like.

Each metadata server 200 manages the independent metadata volume and all the metadata belonging to each volume are maintained in each metadata repository 220.

Each metadata server 200 performs a function of transferring the corresponding volume to different metadata servers and distributing a load when the ratio of the metadata storage space between the respective metadata servers 200 is changed or the user workload is concentrated on the specific volume.

Each metadata server 200 adds or deletes a new metadata server and when the new metadata server is added or deleted, transfers the information on the changed metadata server to the cluster management server 100.

The data server 300 according to the exemplary embodiment of the present invention manages the actual data of the file and is configured to include a data storage manager 310 and a repository 320.

The data server 300 may individually mount and use the plurality of disks when there are a plurality of disks and may be used by being configured as RAID5 or RAID 6 in order to increase the stability of data.

The data server 300 performs the predetermined failure restoration procedure by the control of the cluster management server 100 when the communication with other components 100, 200, and 400 included in the cloud storage 100 is disconnected by various causes (for example, including power failure, network fragmentation, mainboard failure, kernel panic, or the like), thereby performing the normal communication connection with other components.

The client 400 according to the exemplary embodiment of the present invention is configured to include an application program 410 and a client file system 420.

The client 400 mounts the cluster storage, such that the user application program 410 may access the client file system 420. In addition, when the user application program 410 accesses the file, it first requests the metadata to the metadata server 200 including the metadata information of the accessing file among the plurality of metadata servers 200, receives the metadata information of the accessing file transmitted from the metadata server 200 in response to the request, and performs the access (reading or writing functions) to the corresponding data by accessing the corresponding data server 300 among the plurality of data servers 300 based on the positional information of the actual data (or file) included in the received metadata information.

A network 500 according to the exemplary embodiment of the present invention interconnects the various components 100, 200, 300, and 400 configuring the cloud storage 10 at a near distance or a long distance by using a wireless Internet module, a local communication module, or the like. In this case, as the wireless Internet technology, a wireless LAN (WLAN), a Wi-Fi, a wireless broadband (Wibro), a world interoperability for microwave access (Wimas), an IEEE 802.16, a long term evolution (LTE), a high speed downlink packet access (HSDPA), a wireless mobile broadband service (WMBS), or the like, may be provided. Further, as the local communication technology, Bluetooth, ZigBee, ultra wideband (UWB), infrared data association (IrDA), radio frequency identification (RFID), or the like, may be provided.

When the data storage space is not sufficient, the cloud storage 10 according to the exemplary embodiment adds the data server at any time to expand the storage space and when the capacity of the metadata server reaches a limit, it adds new metadata servers to expand the maximally processable number of files to the manager's desired level.

In order to secure the availability of the file system, the cloud storage 10 copies a separate copy to another data server as well as storing the file data in one data server, such that it may be configured to use the stored file in the other data server even though the failure of any data server occurs.

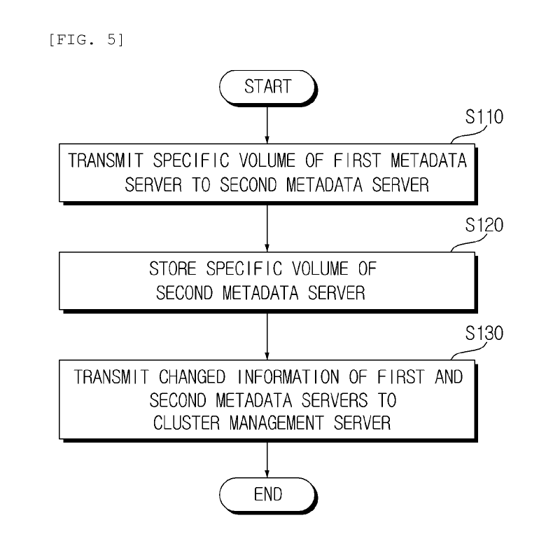

FIG. 5 is a diagram showing a flow chart for explaining a method for migrating metadata between metadata servers according to an exemplary embodiment of the present invention.

Hereinafter, the exemplary embodiment of the present invention will be described with reference to FIGS. 1, 2, and 5.

First, a first metadata server included in the plurality of metadata servers 200 transfers the corresponding specific volume to a second metadata server included in the plurality of metadata servers 200 when the ratio of the metadata storage space between each metadata server is changed or the user workload is concentrated on the specific volume (including the metadata) of the first metadata server (S110).

Further, the second metadata server stores the received volume in the repository included in the second metadata server (S120).

In addition, the first metadata server and the second metadata server each transmit the information on the migration (or deletion) and generation of the volume to the cluster management server 100 to update the contents of the volume list in the cluster management server 100 (S130).

The method for migrating metadata between the metadata servers according to the exemplary embodiment of the present invention does not migrate the actual data stored in the data server and migrates only the metadata having a relatively small size in order to migrate the file system in a fast time.

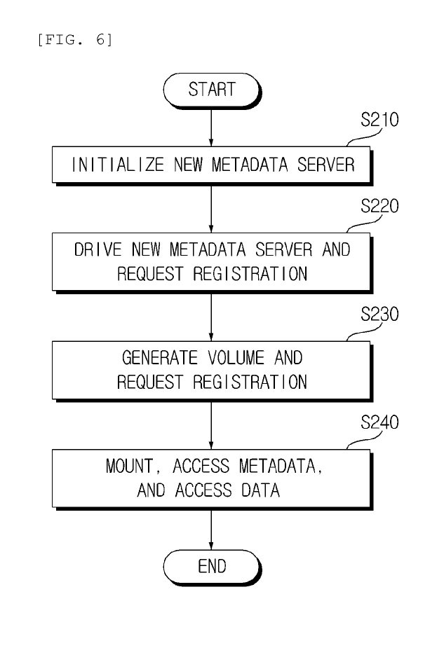

FIG. 6 is a diagram showing a flow chart for explaining a method for adding new metadata servers according to an exemplary embodiment of the present invention.

Hereinafter, the exemplary embodiment of the present invention will be described with reference to FIGS. 1, 2, and 6.

First, new metadata server to be added to the cloud storage 10 initializes the server (or system) through the OS installation, etc., (S210).

The new metadata server drives a metadata server demon and requests the registration of the new metadata server to the cluster management server 100. The cluster management server 100 receiving the registration request of the new metadata server updates the metadata server list based on the request (S220).

The new metadata server generates at least one volume storing the metadata and provides the information on at least one volume generated in the cluster management server 100 (or requests the registration of the information on at least one volume generated in the cluster management server 100). The cluster management server 100 receiving the information on at least one of the newly generated volume updates the volume list based on the information on at least one of the received newly generated volume (S230).

When any client 400 reads the metadata of any file included in the newly added metadata server, any client 400 is mounted in the cluster management server 100, and then, request the return (or transmission) of the metadata to the newly added metadata server, and receives the metadata returned from the newly added metadata server in response to the request. The client 400 accesses (reading or writing) the file existing at the corresponding position of the corresponding data server 300 based on the returned metadata (S240).

According to the exemplary embodiment of the present invention, the load of the metadata may be distributed by adding new metadata servers.

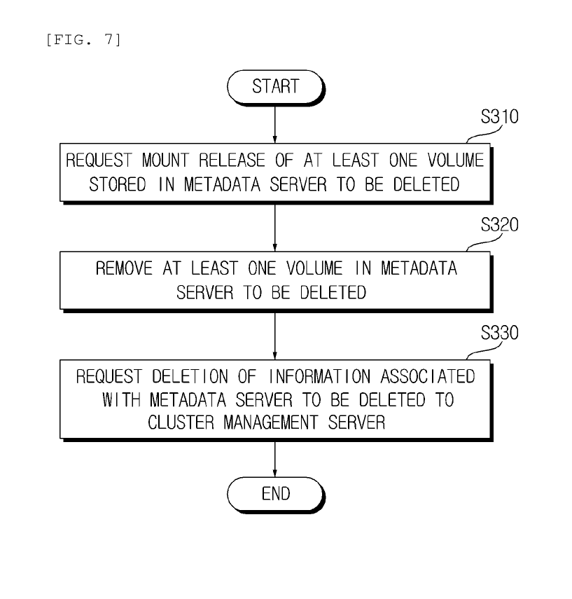

FIG. 7 is a diagram showing a flow chart for explaining a method for removing the existing metadata servers according to an exemplary embodiment of the present invention.

Hereinafter, the exemplary embodiment of the present invention will be described with reference to FIGS. 1, 2, and 7.

First, the client 400 requests the mount release of at least one volume stored in the metadata server 200 to be removed (or deleted) to the cluster management server 100. The cluster management server 100 receiving the mount release request of the at least one volume releases the mount of the corresponding volume (S310).

The corresponding metadata server 200 to be deleted sequentially removes at least one volume managed by the corresponding metadata server 200 (S320).

The corresponding metadata server 200 removes all the volume and then, requests the deletion of the information associated with the corresponding metadata server 200 to the cluster management server 100. The cluster management server 100 receiving the deletion request of the information associated with the corresponding metadata server 200 deletes the information of the corresponding metadata server 200 from the metadata server list and the volume list based on the request (S330).

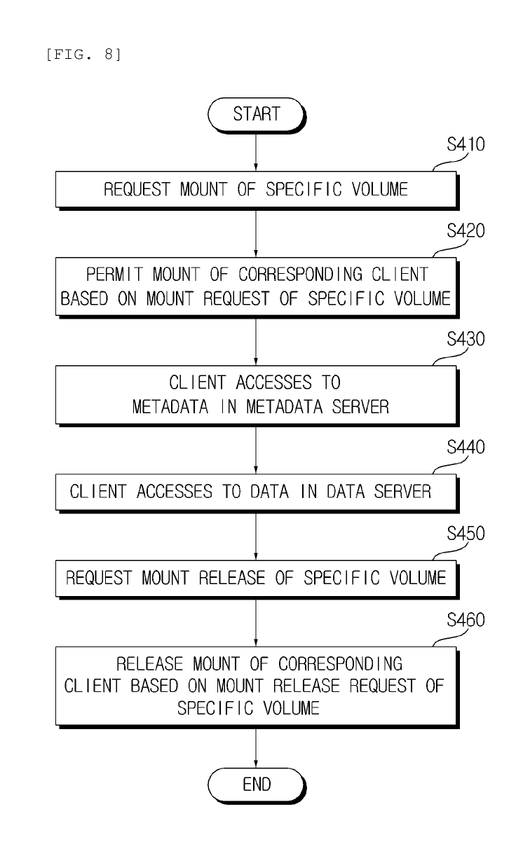

FIG. 8 is a diagram showing a flow chart for explaining a method for allowing a client to mount a cloud storage according to an exemplary embodiment of the present invention.

Hereinafter, the exemplary embodiment of the present invention will be described with reference to FIGS. 1, 2, and 8.

First, the client 400 requests the mount of the specific volume to the cluster management server 100 in order to mount the specific volume (S410).

The cluster management server 100 permits (allows) the mount of the corresponding client 400 based on the request of the specific volume mount of the client 400 (S420).

The client 400 confirms whether the volume is registered through Linux utility such as “df”, requests the metadata information of any file to the metadata server 200 storing the specific volume through the user application program 410, and receives the metadata information of the transmitted file in response to the request from the corresponding metadata server 200 (S430).

The client 400 accesses the corresponding data server 300 in which the file is positioned based on the metadata information of the received file to perform the reading or writing functions (or an access function to the corresponding file) of the corresponding file (S440).

The client 400 requests the mount release of the volume to the cluster management server 100 in order to stop the use of the specific volume (S450).

Further, the cluster management server 100 releases the mount of the client 400 of the corresponding specific volume based on the request of the specific volume mount release of the client 400 (S460).

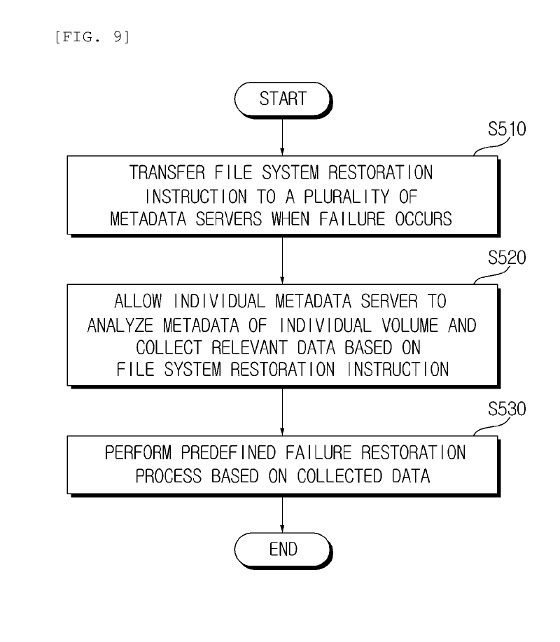

FIG. 9 is a diagram showing a flow chart for explaining a method for processing defects of data servers according to an exemplary embodiment of the present invention.

Hereinafter, the exemplary embodiment of the present invention will be described with reference to FIGS. 1, 2, and 9.

First, the cluster management server 100 monitors the operational state, the network state, or the like, of the plurality of data server 300 included in the cloud storage 10. When any data server 300 among the plurality of data servers 300 disconnects the communication due to various failure environments such as power failure, network fragmentation, mainboard failure, kernel panic, or the like, (or there is no response to the request signal of the cluster management server 100), the cluster management server 100 determines the case as a failure (or trouble) and transfers the file system restoration instruction due to the data failure to the plurality of metadata servers 200 (S510).

Further, each metadata server 200 receiving the file system restoration instruction analyzes the metadata of the volume managed by each metadata server 200 to collect the metadata associated with the corresponding trouble (or, faulty} data server 300 (S520).

Each metadata server 200 performs the predefined failure restoration process based on the collected metadata to perform the failure restoration of the metadata associated with the corresponding faulty data server 300.

In addition, the failure restoration process performed in each metadata server 200 is performed in parallel in all the metadata servers 200 to rapidly restore the failure and thus, may minimize the effect of the user service occurring at the time of the failure of any data server.

Each metadata server 200 normally completing the failure restoration process transmits the information on the failure restoration completion state to the cluster management server 100 (S540).

The cloud storage and the method for managing the same according to the exemplary embodiment use, for example, the plurality of metadata servers, such that they can be applied to any field managing a large amount of metadata.

The spirit of the present invention has just been exemplified. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A cloud storage managing a plurality of files, comprising:
a plurality of metadata servers managing a plurality of metadata associated with the plurality of files;
a plurality of data servers managing the data of the plurality of files; and
a cluster management server managing the plurality of metadata servers and the plurality of data servers.

2. The cloud storage managing a plurality of files of claim 1, further comprising at least one client performing an access to any file among the plurality of files.

3. The cloud storage managing a plurality of files of claim 2, wherein the client mount-connects with the cluster management server and then, performs the access to the plurality of metadata servers or the access to the plurality of data servers.

4. The cloud storage managing a plurality of files of claim 1, wherein the metadata includes at least one of a file name, a file size, an owner, a file generation time, and positional information of a block in the data server.

5. The cloud storage managing a plurality of files of claim 1, wherein the plurality of metadata servers migrates the specific volume from the metadata server including the specific volume to other metadata servers included in the plurality of metadata servers when a ratio of a metadata storage space between the plurality of metadata servers is changed or user workload is concentrated on the specific volume.

6. The cloud storage managing a plurality of files of claim 1, wherein the plurality of metadata servers performs a predefined failure restoration process based on a file system restoration instruction transmitted from the cluster management server.

7. The cloud storage managing a plurality of files of claim 1, wherein the plurality of metadata servers performs an additional function of a new metadata server or a removal function of the existing metadata server.

8. The cloud storage managing a plurality of files of claim 1, wherein the cluster management server includes:
a metadata server controller managing information on the plurality of metadata servers;
a volume controller managing the plurality of volumes associated with the plurality of metadata servers; and
a data server controller managing information on the plurality of data servers.

9. The cloud storage managing a plurality of files of claim 8, wherein the metadata server controller manages at least one state information of a host name, an IP, a CPU model name, CPU usage, a total memory size, memory usage, network usage, and disk usage of each of the plurality of metadata servers.

10. The cloud storage managing a plurality of files of claim 8, wherein the volume controller manages at least one state information of a volume name, a quarter allocated to the volume, volume usage, and workload information accessing the volume of each of the plurality of metadata servers.

11. The cloud storage managing a plurality of files of claim 8, wherein the data server controller manages at least one state information of a host name, an IP, a CPU model name, CPU usage, disk usage, and network usage of each of the plurality of data servers.

12. The cloud storage managing a plurality of files of claim 1, wherein the cluster management server informs the generated event contents through a predetermined e-mail or a short message service of a user when a predetermined event occurs.

13. The cloud storage managing a plurality of files of claim 12, wherein the predetermined event includes at least one of an event indicating when the CPU usage of the data server is excessive, an event indicating when the network usage of the data server is excessive, an event indicating when the disk of the data server is full, an event indicating when the data server starts, an event indicating when the data server stops, an event indicating when the data server does not respond, an event indicating when the CPU usage of the metadata server is excessive, an event indicating when the network usage of the metadata server is excessive, an event indicating when the metadata server starts, an event indicating when the metadata server stops, an event indicating when the metadata server does not respond, and an event indicating when the volume storage space is full.

14. The cloud storage managing a plurality of files of claim 2, wherein the cluster management server includes a remote procedure calling with any one of the plurality of metadata servers, the plurality of data servers, and the at least one client.

15. The cloud storage managing a plurality of files of claim 14, wherein the remote procedure includes at least one of a network call instruction requesting the start of the metadata server, a network call instruction requesting the stop of the metadata server, a network call instruction requesting the addition of a new volume in the metadata server, a network call instruction requesting the removal of the existing volume in the metadata server, a network call instruction monitoring the metadata server information, a network call instruction requesting the start of the data server, a network call instruction requesting the stop of the data server, a network call instruction monitoring the data server information, an network call instruction mounting the file system, and a network call instruction releasing the file system.

16. A method for managing a cloud storage including a plurality of metadata servers managing a plurality of metadata associated with a plurality of files, a plurality of data servers managing the data of the plurality of files, and a cluster management server managing the plurality of metadata servers and the plurality of data servers, the method comprising:
transmitting a specific volume to any second metadata server included in the plurality of metadata servers by any first metadata server included in the plurality of metadata servers when a ratio of a metadata storage space between each of the plurality of metadata servers is changed or user workload is concentrated on the specific volume of the first metadata server;
storing the received volume in a repository included in the second metadata server;
transmitting the information on the volume migration of the first metadata server and the information on the volume generation of the second metadata server to the cluster management server; and
updating the volume list included in the cluster management server based on the transmitted information on the volume migration of the first metadata server and the transmitted information on the volume generation of the second metadata server.

17. A method for managing a cloud storage including a plurality of metadata servers managing a plurality of metadata associated with a plurality of files, a plurality of data servers managing the data of the plurality of files, and a cluster management server managing the plurality of metadata servers and the plurality of data servers, the method comprising:
initializing a new metadata server to be newly added;
driving a metadata server demon of the new metadata server and requesting the registration of the new metadata server to the cluster management server; and
generating at least one volume storing the metadata from the new metadata server and requesting the registration of the at least one generated volume to the cluster management server.
